(19) United States
(12) Patent Application Publication
(10) Pub. No.: US 2026/0290816 A1
(43) Pub. Date: Sep. 24, 2026

(54) COMPOUNDS OF THE LITHIUM OXIDE TYPE WITH A HIGH FLUORINE CONTENT AND CONTAINING PHOSPHORUS, METHOD FOR OBTAINING THEM AND THEIR USES

(71) Applicant: COMMISSARIAT A L'ENERGIE ATOMIQUE ET AUX ENERGIES ALTERNATIVES, Paris (FR)

(72) Inventors: Mathieu COGNIARD, GRENOBLE cedex 09 (FR); Jean-François COLIN, GRENOBLE cedex 09 (FR); Yohan BIECHER, GRENOBLE cedex 09 (FR)

(73) Assignee: COMMISSARIAT A L'ENERGIE ATOMIQUE ET AUX ENERGIES ALTERNATIVES, Paris (FR)

(21) Appl. No.: 19/570,347

(22) Filed: Mar. 18, 2026

(30) Foreign Application Priority Data
Mar. 19, 2025 (FR) 2502782

(51) Int. Cl. H01M 4/58; C01B 25/455; H01M 4/02; H01M 4/04; H01M 4/13915; H01M 10/0525

(52) U.S. Cl. CPC H01M 4/5825; C01B 25/455; H01M 4/0404; H01M 4/13915; H01M 10/0525; C01P 2002/50; C01P 2002/72; C01P 2006/40; H01M 2004/028

(57) ABSTRACT

The present invention relates to lithium oxide compounds with a high fluorine content and containing phosphorus, and to a method for obtaining them. The invention also covers the preparation and use of said compounds as active materials for positive electrodes, in particular metal-ion accumulators, as well as said active materials and electrodes per se.

### CROSS-REFERENCE(S) TO RELATED APPLICATION(S)

This application claims priority to French Application No. 2502782, filed on Mar. 19, 2025, the entire disclosure of which is incorporated herein in its entirety.

### BACKGROUND

The lamellar mixed oxides, often referred to by the acronym NMC (Nickel, Manganese, Cobalt), are materials widely used in lithium-ion battery packs. Their general formula is LiNiₓMn_{y}Co_{z}O₂, where the proportions of nickel, manganese and cobalt may vary to optimize the properties of the material.

NMCs are mainly used as cathode materials in lithium-ion battery packs, which power a variety of electronic apparatus from smartphones to electric vehicles. Their lamellar structure allows an efficient intercalation of lithium ions, which is advantageous for battery pack operation.

NMCs offer a high energy density (typically a specific capacity of around 200 mAh/g, and an energy density of around 740 Wh/kgmaterial), allowing more energy to be stored in a given volume.

However, the cost of NMCs is high, not to say problematic, in particular because of the presence of cobalt and nickel, which are expensive materials subject to wide price variations. And the extraction of cobalt poses ethical problems, with a high human and environmental cost.

Materials with a disordered cubic structure such as NaCl (or disordered rocksalt) have been proposed as a low-cost alternative to current NMC technology.

Some DRSs have the advantage of being composed mainly of manganese, an abundant metal, while delivering electrochemical performance comparable to that of NMCs, with capacities of the order of 250 mAh/g and an energy density of the order of 900 Wh/kg material.

However, the major disadvantage of DRS materials is currently poor cycling stability, with a fairly rapid drop in performance; this degradation is mainly linked to the irreversible structural evolution (cation migration and local decrease in the Li/Mn ratio) of the material caused by the participation of oxygen ions in the oxidation-reduction methods. This structural change results in a fall in the capacity of the cell, but also in a reduction in the average discharge potential during cycling.

### SUMMARY

One aim of the invention is therefore to provide compounds that do not have the above-mentioned disadvantages.

The present invention relates to lithium oxide compounds with a high fluorine content and containing phosphorus, and to a method for obtaining them. The invention also covers the preparation and use of said compounds as active materials for positive electrodes, in particular metal-ion accumulators, as well as said active materials and electrodes per se.

In particular, one objective of the invention is to provide compounds that may be successfully used for the preparation of positive electrodes, in particular metal-ion accumulators (the metal being in particular an alkali or alkaline-earth metal, for example Li), with high capacity (in particular more than 200, 250 or 300 mAh/g) and low cost.

Another aim of the invention is to provide positive electrode materials that limit the degradation of performance, in particular with an advantageous retention of cycling capacity, notably higher than that relating to the devices in the prior art, while doing away with metals that are critical from an economic and/or toxic point of view, such as cobalt.

The invention also relates to a compound of the following formula (I):

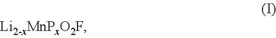

with:

$$0 < x \leq 0.25 .$$

Surprisingly, and without wishing to restrict ourselves to any one theory, the combination, in the compounds of the invention, of a high fluorine content (33% fluorine in the anionic site) and the presence of tetrahedra PO4 (as formed when phosphorus crystallizes) in the disordered cubic crystal network limits the deterioration in performance by inhibiting the structural evolution of the material and therefore allowing a greater stability. The cationic sites of the metals in the rocksalt structure are octahedral. It is therefore not easy to envisage a solid solution using phosphorus.

Thus the Li/Mn ratio is (2-x), and the degree of oxidation of the manganese in the compound of formula (I) according to the invention is (3-4×).

The Li/Mn ratio is therefore greater than or equal to 1.75 and less than 2.

The oxidation state of the manganese is therefore greater than or equal to 2 and less than 3.

These values allow to obtain a high theoretical manganese capacity (in particular 265 mAh/g or even more than 300 mAh/g), while achieving an improved stability.

According to a particular embodiment, x is such that 0<x≤0.20; in particular such that 0<x≤0.15; more particularly such that 0<x≤0.10.

According to a particular embodiment, x is such that x≥0.05; in particular such that x≥0.1.

In a particular embodiment, x is about 0.05; about 0.1; about 0.15; about 0.2; or about 0.25.

In a particular embodiment, x is about 0.1.

According to a particular embodiment, the compound of the invention is chosen from the following compounds:

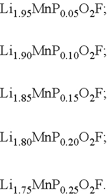

According to a particular embodiment, the compound of the invention has a disordered cubic structure of the NaCl type, or a substantially disordered cubic structure of the NaCl type.

The so-called disordered cubic structure of the NaCl type is also known as “disordered rocksalt”, which may also be referred to by the acronym DRS. This structure is generally characterized by a statistical distribution of cations and anions within their crystallographic site, and by an excess of lithium in relation to the transition metals (TM), in this case manganese. Without wishing to restrict ourselves to any particular theory, this excess lithium is likely to ensure the ionic conductivity of the material.

According to a particular embodiment, the compound of the invention is of NaCl-type disordered cubic structure, or substantially of NaCl-type disordered cubic structure, said formula (I) being such that x<0.25, in particular such that x≤0.20, x<0.20, x≤0.15 or x≤0.10.

According to another aspect, the present invention also relates to a method for preparing a compound of formula (I) as defined above, comprising a mechanosynthesis step starting from the following precursors, in particular in powder form:
lithium oxide (Li₂O) and/or Li₂CO₃,
lithium phosphate (Li₃PO₄),
lithium fluoride (LiF) and/or MnF₂, and
at least one manganese oxide.

All the embodiments previously described in relation to the compound of formula (I) of the invention also apply here, alone or in combination.

By “mechanosynthesis” is meant in particular a method consisting of milling together the various precursors until said compound of formula (I) is obtained.

The compound of formula (I) is therefore typically obtained in powder form at the end of the mechanosynthesis step.

The quantities of precursors to be used to obtain said compound of formula (I) are easily calculated by a person skilled in the art.

According to a particular embodiment, the at least one manganese oxide is Mn₂O₃ and/or MnO.

In a particular embodiment, the mechanosynthesis step is carried out by planetary milling.

The planetary mills are well known to the person skilled in the art. For example, it may be a milling bowl made of stabilized zirconia comprising zirconia beads, for example with a diameter of around 5 mm.

According to another aspect, the invention also relates to a compound, in particular in powder form, capable of being obtained according to one of the methods defined above.

According to another aspect, the invention also relates to the use of a compound of formula (I) as defined above for the preparation of an electrode, in particular a positive electrode, in particular for a metal-ion, in particular Li-ion, battery or accumulator.

All the embodiments previously described in relation to the compound of formula (I) of the invention also apply here, alone or in combination.

According to another aspect, the invention also relates to a powder consisting of or comprising particles of compound of formula (I) as defined above.

All the embodiments previously described in relation to the compound of formula (I) of the invention also apply here, alone or in combination.

In a particular embodiment, the particles have a size of between 50 nm and 30 μm, in particular between 50 nm and 10 μm.

By “size” we mean in particular the largest dimension of a particle.

In particular, this size is an average size determined by laser granulometry.

In a particular embodiment, the powder as defined above further comprises an electronically conductive additive, in particular carbon particles, and optionally a binder.

The electronically conductive additive, well known to the person skilled in the art, may consist of or comprise hard carbon and/or graphite.

“Carbon particles” refers to particles that make up carbon black.

By “carbon black” we mean in particular a pulverulent composition of carbon in amorphous form, which is in particular in the form of a powder consisting of or comprising spherical or spheroidal particles of 5 to 500 nm (largest dimension), in particular less than 100 nm.

In a particular embodiment, the compound particles of formula (I) are mixed with an electronically conductive additive, in particular carbon particles, to form a composite material. In this composite, the particles of additive, in particular carbon, are distributed in such a way that they envelop the particles of compound of formula (I).

According to a particular embodiment, the ratio of the mass of the particles of compound of formula (I) to the mass of electronically conductive additive, in particular carbon particles, is between 90/5 or 80/10 and 50/40, this ratio being for example 75/15.

According to another particular embodiment, the ratio of the mass of compound of formula (I) to the mass of electronically conductive additive, in particular carbon particles, is between 96/2 and 90/5.

In a particular embodiment, the powder as defined above further comprises an electronically conductive additive, in particular carbon particles, and optionally a binder.

In a particular embodiment, the binder is a polymer, in particular chosen from polyvinylidene fluoride (PVDF).

According to a particular embodiment, the powder as defined above comprises, by mass:
from 50 to 80% of particles of compound of formula (I) as defined above, in particular 75%;
10 to 30% carbon particles, in particular 15%; and
5 to 20% binder, in particular 10%.

According to a particular embodiment, the powder as defined above comprises, by mass:
from 90 to 96% of particles of compound of formula (I) as defined above;
from 2 to 6% of carbon particles, in particular; and
2 to 4% binder.

According to another aspect, the invention also relates to an electrode, in particular a positive electrode, in particular for a metal-ion battery or accumulator, in particular a Li-ion battery, comprising a compound of formula (I) as defined above.

All the embodiments previously described in relation to the compound of formula (I) of the invention also apply here, alone or in combination.

According to another aspect, the invention also relates to a method for preparing an electrode, in particular a positive electrode, in particular for a metal-ion battery or accumulator, in particular a Li-ion battery, said method comprising a step A) of bringing a powder constituted by or comprising a compound of formula (I) as defined above, an electronically conductive additive, in particular carbon particles, and optionally a binder, into contact with a conductive support.

All the embodiments previously described in relation to the compound of formula (I) of the invention also apply here, alone or in combination.

In a particular embodiment, the conductive support is a metal support, the metal being aluminum (Al) in particular.

According to a particular embodiment, the method of the invention as defined above comprises:
A0) a step of preparing an ink by adding a solvent, in particular chosen from N-methyl-2-pyrrolidone (NMP), to a powder consisting of or comprising particles of compound of formula (I), an electronically conductive additive, in particular carbon particles, and optionally a binder, the binder being for example previously dissolved in a solvent, in particular N-methyl-2-pyrrolidone (NMP), as defined above, and, optionally, homogenization, in particular by mechanical stirring, in order to obtain a suspension;
A) a step A) of bringing a suspension as obtained at the end of step A) into contact with a conductive support, in particular by coating, for example of the “doctor blade” type, in order to obtain a device;
B) optionally, a step of drying said device;
C) optionally a shaping step, in particular by pelletizing, of said device, possibly dried, in particular at a temperature of between 5° and 100° C., in particular at approximately 60° C., and/or for 1 to 48 hours, for example for approximately 24 hours.

According to another aspect, the invention also relates to a battery or accumulator comprising an electrode, in particular a positive electrode, comprising a compound of formula (I) as defined above, having in particular a theoretical capacity greater than 200 mAh/g.

All the embodiments previously described in relation to the compound of formula (I) of the invention also apply here, alone or in combination.

According to a particular embodiment, the battery or the accumulator as defined above further comprises at least one electrolyte, a separator, in particular microporous, and a negative electrode, in particular consisting of or comprising a metal, more particularly Li.

These elements are well known to the person skilled in the art, who will be able to select them, in particular from commercial elements, as required.

The negative electrode may also be made of or comprise hard carbon or graphite.

The batteries and the accumulators of the invention can, for example, be used in the field of electrical storage, particularly stationary, or in electric mobility, particularly for portable or wearable electronics, for integration in fibers and/or cables, particularly in the context of wired battery pack, or for medical use.

In particular, the batteries and the accumulators of the invention may be used in the field of the electric mobility, especially for electric vehicles, rechargeable hybrid electric vehicles, hybrid vehicles or electric 2-wheelers.

In particular, the batteries and the accumulators of the invention may be used in the field of portable electrical equipment, in particular telephones, portable computers or portable tools.

According to another aspect, the invention also relates to a battery pack comprising a battery or an accumulator as defined above.

All the embodiments previously described in relation to the compound of formula (I) of the invention also apply here, alone or in combination.

According to another aspect, the invention also relates to a portable electrical or electric mobility system, comprising a battery pack as defined above.

All the embodiments previously described in relation to the compound of formula (I) of the invention also apply here, alone or in combination.

DEFINITIONS: As understood here, the value ranges in the form of “x-y” or “from x to y” or “between x and y” include the terminals x and y, the integers between these terminals, and all other real numbers between these terminals. For example, “1-5”, or “from 1 to 5” or “between 1 and 5” refer to the integers 1, 2, 3, 4 and 5, as well as all other real numbers between 1 and 5. Preferred embodiments comprise each individual integer in the value range, as well as any sub-combination of these integers and any set of real numbers between these integers. For example, the preferred values for “1-5” may comprise the integers 1, 2, 3, 4, 5, 1-2, 1-3, 1-4, 1-5, 2-3, 2-4, 2-5, etc.

As used in this description, the term “about” refers to a range of values within ±10% of a specific value. For example, the term “about 20” comprises the values of 20±10%, i.e., the values of 18 to 22.

For the purposes of this description, the percentages refer to percentages by mass in relation to the total mass of the formulation, unless otherwise stated.

### DESCRIPTION OF THE DRAWINGS

The foregoing aspects and many of the attendant advantages of this invention will become more readily appreciated as the same become better understood by reference to the following detailed description, when taken in conjunction with the accompanying drawings, wherein:

FIG. 1 shows the diffractogram of Li₂₋ₓMnPₓO₂F materials of the invention, according to example 7.

FIG. 2 shows the evolution of the mesh parameter a of the compounds of the invention as a function of the phosphorus content, according to example 7.

FIG. 3 shows the plot of the average charge and discharge potentials ((V_{charge}+V_{discharge})/2) of the compounds of the invention, as a function of the number of cycles, according to example 8.

### DETAILED DESCRIPTION

The compounds below were obtained by mechanosynthesis, which is likely to favor the incorporation of high fluorine content into the materials. The compositions in question are described in the following examples and Table 1, and their synthesis may be described by the following chemical reaction:

$$( \frac{1}{2} - 2 x ) {Li}_{2} O + {x Li}_{3} {PO}_{4} + LiF + ( \frac{1}{2} - 2 x ) {Mn}_{2} {O}_{3} + 4 x MnO \to \\ {Li}_{2 - x} {MnP}_{x} {O}_{2} F$$

TABLE 1
Masses of precursors used to synthesize Li₂₋ₓMnPₓO₂F materials:

| | Mn₂O₃ (g) | MnO (g) | LiF (g) | Li₂O (g) | Li₃PO₄ (g) |
|---|---|---|---|---|---|
| Li₂MnO₂F | 3.295 | | 1.082 | 0.673 | |
| Li_{1.95}MnP_{0.05}O₂F | 2.609 | 0.586 | 1.072 | 0.494 | 0.239 |
| Li_{1.9}MnP_{0.1}O₂F | 1.938 | 1.161 | 1.061 | 0.367 | 0.474 |
| Li_{1.85}MnP_{0.15}O₂F | 1.279 | 1.724 | 1.051 | 0.242 | 0.704 |
| Li_{1.8}MnP_{0.2}O₂F | 0.633 | 2.277 | 1.047 | 0.120 | 0.929 |
| Li_{1.75}MnP_{0.25}O₂F | | 2.819 | 1.031 | | 1.150 |

In these examples, the bowl is loaded under an inert atmosphere, and the precursors are dried (80° C.) under vacuum beforehand. The reaction mixture was then milled for 40 hours at 450 rpm using a Retsch PM 100 planetary mill. After synthesis, the materials are collected in a glove box and stored under argon gas.

### Example 1

Preparation of Li₂MnO₂F (reference outside the invention): 3.367 g Li₂O, 5.411 g LiF, 16.473 g Mn₂O₃ and 400 g zirconia beads (d=5 mm) were added to a stabilized zirconia milling bowl (250 mL).

### Example 2

Preparation of Li_{1.95}MnP_{0.05}O₂F of the invention: 0.494 g Li₂O, 1.072 g LiF, 2.609 g Mn₂O₃, 0.586 g MnO, 0.239 g Li₃PO₄ and 75 g zirconia beads (d=5 mm) were added to a stabilized zirconia milling bowl (250 mL).

### Example 3

Preparation of Li_{1.9}MnP_{0.1}O₂F of the invention: 0.367 g Li₂O, 1.061 g LiF, 1.938 g Mn₂O₃, 1.161 g MnO, 0.474 g Li₃PO₄ and 75 g zirconia beads (d=5 mm) were added to a stabilized zirconia milling bowl (250 mL).

### Example 4

Preparation of Li_{1.85}MnP_{0.15}O₂F of the invention: 0.242 g Li₂O, 1.051 g LiF, 1.279 g Mn₂O₃, 1.724 g MnO, 0.704 g Li₃PO₄ and 75 g zirconia beads (d=5 mm) were added to a stabilized zirconia milling bowl (250 mL).

### Example 5

Preparation of Li_{1.8}MnP_{0.2}O₂F of the invention. 0.120 g Li₂O, 1.047 g LiF, 0.633 g Mn₂O₃, 2.277 g MnO, 0.929 g Li₃PO₄ and 75 g zirconia beads (d=5 mm) were added to a stabilized zirconia milling bowl (250 mL).

### Example 6

Preparation of Li_{1.75}MnP_{0.25}O₂F of the invention. 1,031 g LiF, 2,819 g MnO, 1,150 g Li₃PO₄ and 75 g zirconia beads (d=5 mm) were added to a stabilized zirconia milling bowl (250 mL).

### Example 7

Characterization of the compounds of the invention.

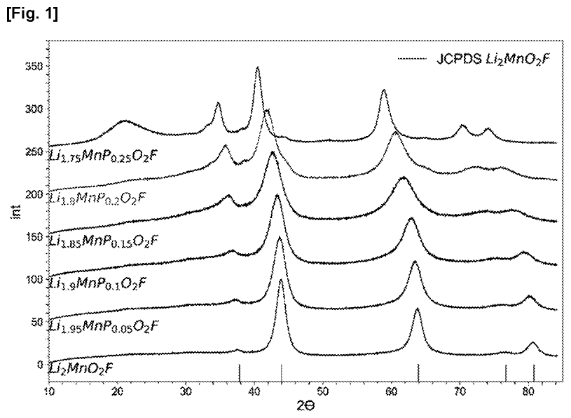

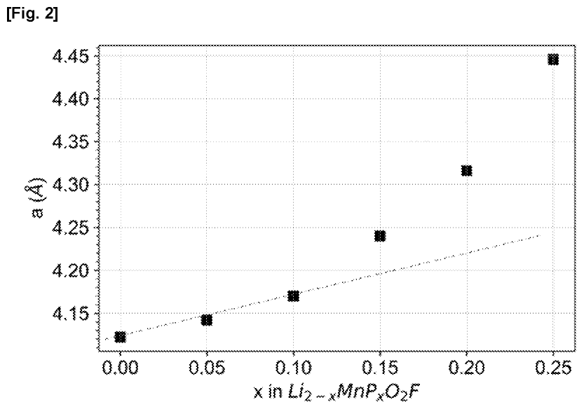

The synthesized materials are characterized by X-ray diffraction (FIG. 1) to determine their crystallographic structure. For x<0.15 in particular, the structure of the materials is disordered cubic of the NaCl type (space group Fm-3m), and the evolution of the lattice parameter (FIG. 2) varies linearly with the level of phosphorus, which suggests that the PO₄ groups are located within the interstitial sites of the network. When x>=0.15, the lattice parameter no longer varies linearly with x, and in the case of x=0.2 and 0.25, the appearance of new diffraction peaks suggests the formation of a new phase.

### Example 8

Preparation of electrodes comprising a material of the invention.

The materials described above have been used as positive electrode active materials in Li-ion battery packs.

To produce electrodes, an ink was formulated by dispersing the active material, C65 carbon (Imerys) and PVDF (polyvinylidene fluoride-Solvay 5130) in a solvent, NMP (1-methyl-2-pyrrolidone-Sigma-Aldrich). This ink is coated onto an aluminum current collector directly in the glove box.

The final mass composition of the electrode is as follows: 75% active material, 15% carbon C65 and 10% PVDF binder. 14 mm pellets are cut and calendered at 10 t using a press. The grammage of the electrodes is around 1 mg/cm². Button batteries are assembled in a glovebox using lithium metal as the negative and reference electrode, and Celgard 2400 as separators. The electrolyte used is LP100 (1M LiPF6 in EC/PC/DMC 1/1/3 vol.). The cycling benches used are produced by Arbin. The current applied corresponds to a C-rate of C/10, using 300 mA·h/g as the theoretical capacity. The potential cycling terminals are 1.5 V and 4.8 V.

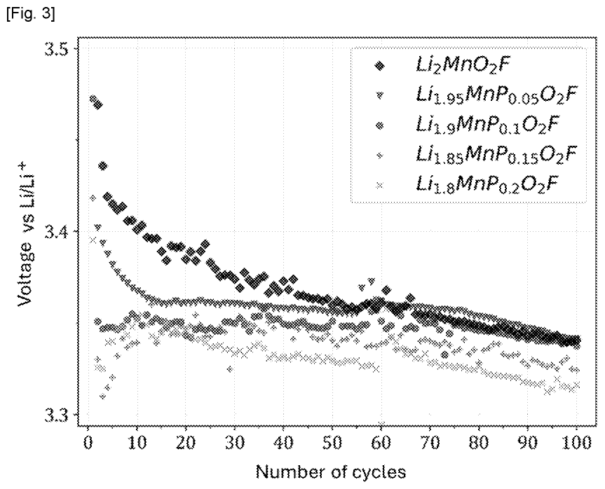

The compounds x=0.05 and x=0.1 have an excellent cycling stability, with around 150 mAh/g remaining after 100 cycles, i.e. 75% more than the reference. The role of phosphorus on the structure of the material may also be studied by plotting the average charge and discharge potentials, as shown in FIG. 3. This treatment eliminates the contribution of ohmic resistance to the change in mean potential.

While illustrative embodiments have been illustrated and described, it will be appreciated that various changes can be made therein without departing from the spirit and scope of the invention.

The embodiments of the invention in which an exclusive property or privilege is claimed are defined as follows:

1. A compound of the following formula (I): 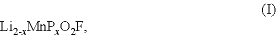
with:
$$0 < x \leq 0.25 .$$

2. The compound of formula (I) according to claim 1, wherein x is such that 0<x≤0.20; in particular such that 0<x≤0.15; more particularly such that 0<x≤0.10.

3. The compound according to claim 1, which is chosen from the following compounds:

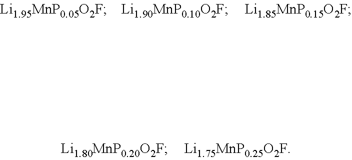

4. The compound according to claim 1, which has a disordered cubic structure of the NaCl type, or a substantially disordered cubic structure of the NaCl type.

5. A method for preparing a compound of formula (I) according to claim 1, comprising a mechanosynthesis step starting from the following precursors, in particular in powder form:
lithium oxide (Li₂O) and/or Li₂CO₃,
lithium phosphate (Li₃PO₄),
lithium fluoride (LiF) and/or MnF₂, and
at least one manganese oxide.

6. An electrode, in particular a positive electrode, in particular for a metal-ion battery or accumulator, comprising a compound of formula (I) according to claim 1.

7. A method for preparing an electrode, in particular a positive electrode, in particular for a metal-ion battery or accumulator, said method comprising a step A) of bringing a powder constituted by or comprising a compound of formula (I) according to claim 1, an electronically conductive additive, in particular carbon particles, and optionally a binder, into contact with a conductive support.

8. A battery or accumulator comprising an electrode, in particular a positive electrode, comprising a compound of formula (I) according to claim 1, having in particular a theoretical capacity greater than 200 mAh/g.

9. A battery pack comprising a battery or an accumulator as claimed in claim 8.

10. A portable electrical or electric mobility system comprising a battery pack as claimed in claim 9.
